(19) United States
(12) Patent Application Publication
(10) Pub. No.: US 2026/0237142 A1
(43) Pub. Date: Aug. 13, 2026

(54) 3D MODEL GENERATION SYSTEM AND METHOD THEREOF

(71) Applicant: METAI TECHNOLOGY CO., LTD., TAIPEI CITY (TW)

(72) Inventors: CHIA-CHENG HSU, TAIPEI CITY (TW); SHU-WEN CHEN, TAIPEI CITY (TW)

(21) Appl. No.: 19/049,289

(22) Filed: Feb. 10, 2025

(51) Int. Cl. G06T 15/02; G06F 16/14; G06T 19/20

(52) U.S. Cl. CPC G06T 15/02; G06F 16/148; G06T 19/20; G06T 2200/24; G06T 2219/2004; G06T 2219/2016

(57) ABSTRACT

The present invention relates to a 3D model generation system and method for receiving an object information file through a user device. The object information file contains predefined drawing information, which includes one or more predefined objects and predefined object information. The user device retrieves the predefined object information from the object information file and retrieves an original model file based on the predefined object information. The system generates one or more virtual object models based on the object's dimensions and physical material parameters of the original model file. Subsequently, all generated virtual object models are arranged based on the object positions, creating a simulated object environment corresponding to predefined drawing information.

### BACKGROUND OF THE INVENTION

### 1. Field of the Invention

The present invention relates to a 3D model generation system and method thereof, and in particular to a 3D model generation system and method thereof capable of generating a 3D model according to an object information file.

### 2. Description of the Prior Art

3D models play a vital role in modern design, manufacturing and engineering. Compared to 2D drawings, 3D models can provide a more intuitive and comprehensive visual representation, helping designers and engineers to understand and analyze the structure and function of a product more accurately.

With the continuous advancement of computer technology and software tools, 3D model generation technology is also developing rapidly. Modern 3D modeling tools, such as AutoCAD, SolidWorks, and Fusion 360, offer powerful features to support modeling needs ranging from simple geometries to complex organic structures.

The modeling technology of 3D models often requires repeated manual adjustments and optimizations, which requires operators with extensive professional knowledge and skills. This may make the job more difficult and increase the risk of error for inexperienced or unskilled operators.

Based on the foregoing, if the 2D object information files can be converted into 3D models, it will have broad prospects and importance in industrial applications and can also improve design accuracy and manufacturing efficiency. However, this process still faces challenges such as excessive cost, high time consumption, and needs for professional skills and consistency difficulties.

Therefore, the subject application designs a system and method to allow users to input object information files and multiple parameters to automatically generate 3D models, to effectively achieve the purpose of converting 2D object information files into 3D models. The invention should be an optimal solution.

### SUMMARY OF THE INVENTION

A 3D model generation system includes: a user device, comprising a model generation application program unit, wherein the model generation application program unit comprises: a database module, used to store model names of multiple objects, wherein each of the model names corresponds to an original model file, and the original model file has at least one physical material parameter; an identification module, connected to the database module to receive an object information file, wherein the object information file comprises a predefined drawing information and a predefined object information, the predefined object information can be included or not included in the predefined drawing information, the predefined drawing information comprises at least one predefined object, the identification module can extract the predefined object information. and the predefined object information comprises at least an object name, an object type, an object position and an object size; and a model generation module, connected to the database module and the identification module to search the corresponding model name and the original model file in the database module based on each object name or/and the object type, and generate at least one virtual object model from the original model file based on the object size and the physical material parameter, and arrange all the generated virtual object models based on the object position to complete a simulated object environment corresponding to the predefined drawing information.

More specifically, if the model generation module fails to search the corresponding model name and the original model file in the database module, the model generation module can scan multiple 2D image layers in the predefined drawing information to simulate a 3D form, and the 3D form is archived in the database module according to the object name to be used as a new original model file.

More specifically, the model generation module scans multiple 2D image layers and is further capable of analyzing an object curve of the predefined object in the object information file to simulate the 3D form for the object curve parameter.

More specifically, the physical material parameter comprises one or at least one parameter of a color parameter, a texture parameter, a reflectivity parameter, a specular highlight parameter, a roughness parameter, a metallic property parameter, a transparency parameter, an opacity parameter, an emissive property parameter, a normal map parameter, a bump map parameter, an ambient occlusion parameter, a glossiness parameter, a subsurface scatterings parameter, and an anisotropy parameter.

More specifically, the model generation module is further capable of changing the virtual object model according to a physical property parameter so that the virtual object model has corresponding physical properties.

More specifically, the physical property parameter comprises one or at least one parameter of a mechanical property-related parameter, a thermal property-related parameter, an electrical property-related parameter, a density parameter, a specific gravity parameter, and a viscosity parameter.

More specifically, the model generation module is further capable of changing the virtual object model according to an object motion attribute parameter so that the virtual object model has corresponding motion behavior.

More specifically, the object motion attribute parameter comprises one or at least one parameter of a displacement parameter, a moving distance parameter, a speed parameter, an acceleration parameter, a duration parameter, a push or pull parameter, an object motion parameter, a momentum parameter, a kinetic energy parameter, a potential energy parameter, a power parameter, an angular momentum parameter, a moment inertia parameter, and a torque parameter.

A 3D model generation method comprises:
(1) receiving an object information file through an user device, wherein the object information file has a predefined drawing information and a predefined object information, the object information file has a predefined drawing information and a predefined object information, the predefined object information can be included or not included in the predefined drawing information, the predefined drawing information has at least one predefined object, the user device further stores model names of multiple objects, wherein each of the model names corresponds to an original model file, and the original model file comprises at least one physical material parameter;
(2) for the object information file, extracting the predefined object information, wherein the predefined object information comprises at least an object name, an object type, an object position, and an object size;
(3) searching the corresponding model name and the original model file based on each object name or/and the object type, generating at least one virtual object model from the original model file based on the object size and the physical material parameter, and arranging all the generated virtual object models based on the object position to complete a simulated object environment corresponding to the predefined drawing information.

### BRIEF DESCRIPTION OF THE DRAWINGS

FIG. 1A is a schematic diagram of the overall architecture of the 3D model generation system and its method of the present invention.

FIG. 1B is a schematic diagram of the architecture of the model generation application program unit of the 3D model generation system and its method of the present invention.

FIG. 2A is a schematic diagram of the first set of corresponding embodiments of the real object information file and the 3D model of the 3D model generation system and its method of the present invention.

FIG. 2B is a schematic diagram of the second set of corresponding embodiments of the real object information file and the 3D model of the 3D model generation system and its method of the present invention.

FIG. 2C is a schematic diagram of the third set of corresponding embodiments of the real object information file and the 3D model of the 3D model generation system and its method of the present invention.

FIG. 3 is a schematic diagram illustrating the correspondence between real photos and simulated pictures of the 3D model generation system and its method of the present invention.

FIG. 4 is a flow chart of the 3D model generation system and its method of the present invention.

### DETAILED DESCRIPTION OF THE INVENTION

Other technical contents, features and effects of the present invention will be clearly presented in the following detailed description of the preferred embodiments with reference to the drawings.

The connection described below in the present invention refers to the connection behavior generated by wired or wireless connection to enable unidirectional or bidirectional transmission of digital signals and/or analog signals between electronic elements.

With respect to the processor described below in the present invention, it is an MCU (Micro Controller Unit), and the MCU contains at least a CPU, memory (such as ROM and RAM), and peripheral devices (such as ADCs, DACs, GPIOs, and PWMs), wherein actions, instructions, variables, and other data that can be programmed are written into the memory, and then executed sequentially by the CPU through the programmed actions.

As used herein, the articles “a”, “an” and “any” refer to the grammar of one or more than one (i.e. at least one) item, unless a specific number is specified. For example, “an element” means one element or more than one element.

With respect to the present invention, the following references to “unit,” “device,” and “module” refer to any name of hardware that is capable of carrying out the specific function or/and purpose of the present invention, but that the subject application is not limited to hardware of such names.

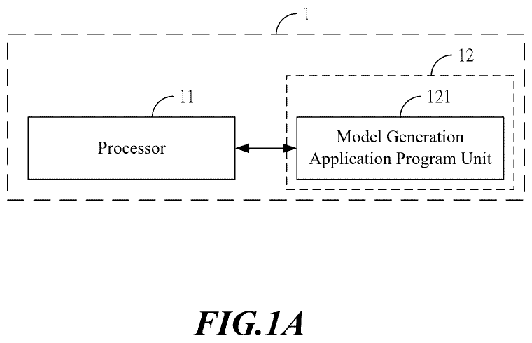

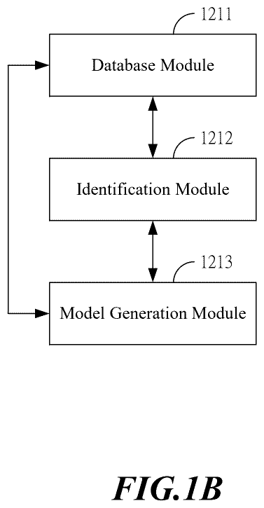

Please refer to FIG. 1A, which is a schematic diagram of the overall structure of the 3D model generation system and its method of the present invention. As shown in the figure, the 3D model generation system includes a user device 1. The user device 1 is any electronic apparatus capable of computing and executing software applications, such as a desktop computer, a laptop computer, or a server device.

The user device 1 includes at least one processor 11 and at least one computer-readable recording medium 12. The computer-readable recording medium 12 has a model generation application program unit 121 within it. The computer-readable recording medium 12 further stores computer-readable instructions. When the computer-readable instructions are executed by the processor 11, the model generation application program unit 121 can be enabled for operation.

As shown in FIG. 1B, the model generation application program unit 121 includes a database module 1211, an identification module 1212, and a model generation module 1213.

The database module 1211 is used to store model names of various objects, and each model name corresponds to an original model file. The original model file has at least one physical material parameter.

The physical material parameters are described as follows:
(1) Color: It defines the basic hue of a material, which is the basic color representation of an object under light.
(2) Texture: It is a 2D image applied to the surface of a material, so as to simulate details such as wood grain, cloth texture, metal scratches, etc.
(3) Reflectivity: It controls the degree to which a material reflects light. High reflectivity makes a material appear brighter or mirror-like.
(4) Specular highlights: They are bright spots formed by the direct reflection of light on the surface of a material, which affects the gloss of the material.
(5) Roughness: It controls the scattering degree of the reflected light. Low roughness means a smoother surface and clearer reflections. High roughness makes the reflections more blurred and diffuse. Roughness is used to adjust the smoothness of the surface of material, and it is suitable for the visual effects of different materials, such as mirror metal and frosted plastic.
(6) Metallic properties: They determine whether the material has metallic properties. Metallic material has specific reflection and color properties. In PBR (Physically Based Rendering) materials, the metallic property parameters are used to distinguish between metal material and non-metal material, affecting reflection and gloss effects.
(7) Transparency: It defines the ability of a material to transmit light. Fully transparent materials allow light to pass through unobstructed, while partially transparent materials have varying degrees of blockage.
(8) Opacity: It is the opposite of transparency and controls the degree of occlusion of a material. 0% opacity is completely transparent, and 100% is completely opaque.
(9) Emissive properties: They define whether the material is self-luminous and the intensity and color of the light.
(10) Normal maps: They use normal maps to add details and bump effects to surfaces and change the reflection direction of light to simulate uneven surfaces. The detail and realism of the surface of model can be enhanced without increasing the number of polygons.
(11) Bump Maps: They use the grayscale image to simulate the unevenness of the surface, affecting the reflection of light and making the surface appear to have subtle changes in height. It is used to add surface details such as textures, scratches, etc., but the effect is simpler than normal maps.
(12) Ambient occlusion: It simulates the occlusion effect of light in recessed areas, enhancing the depth and details of the object. It is used to improve the realism of 3D models under lighting, especially at seams and corners.
(13) Glossiness: It controls the smoothness degree of the surface of material and affects the sharpness and scattering degree of the reflected light. It is related to roughness and used to simulate the gloss effects of varied materials, such as high-gloss mirrors and low-gloss frosted surfaces.
(14) Subsurface Scattering: It simulates the effect of light penetrating the surface of a material and scattering inside, affecting the transparency and softness of the material. It is used on materials such as skin, wax, and translucent plastics, so as to enhance the realism and natural appearance.
(15) Anisotropy: It controls the directionality of light reflected from the surface and simulates the reflective properties of brushed metal, hair, and other materials. It is used for materials that need to exhibit directional reflections, such as brushed steel and textiles.

The identification module 1212 is used to receive an object information file. The object information file has a predefined drawing information and a predefined object information. The object information file has a predefined drawing information and a predefined object information. The predefined object information can be included or not included in the predefined drawing information. The predefined drawing information has at least one predefined object, and the identification module can extract the predefined object information. The predefined object information includes at least an object name, an object type, an object position and an object size.

The predefined drawing information of the present invention can have at least one or multiple 2D predefined objects. The multiple 2D predefined objects can be constructed into a spatial environment (the predefined drawing information is, for example, a factory building, The drawing file contains multiple machines and space configurations to construct a virtual object environment of a factory).

The object information file of the present invention can have various file contents, as explained below:
(1) The object information file can have a simple drawing file (only having predefined drawing information, such as line and graphic design).
(2) The object information file can have a simple drawing file (only having predefined drawing information, such as line and graphic design) and a text file containing information (with predefined object information). If the object information file is a graphic file with information that is not sufficient to implement the predefined object information, the object information file must be implemented by adding a text file with more predefined object information.
(3) The object information file may include a drawing file containing information (having lines, graphic design and predefined object information, e.g., a 2D drawing file such as a CAD drawing file or a Gerber drawing file).
(4) The object information file can have a drawing file containing information (having lines, graphic design and predefined object information, such as a The object information file may include a drawing file containing information (having lines, graphic design and predefined object information, e.g., a 2D drawing file such as a CAD drawing file or a Gerber drawing file) and a text file containing information (having predefined object information). The predefined object information of the drawing file and the text file can be partially repeated or completely different.
(5) The object information file can have a simple drawing file (only predefined drawing information), a drawing file containing information (with lines, graphic design and predefined object information) and a text file containing information (with predefined object information). The predefined object information of the drawing file and the text file can be partially repeated or completely different.
The model generation module 1213 is connected to the database module 1211 and the identification module 1212 to search the database module 1211 for the corresponding model name and the original model file based on each object name or/and object type, and generate at least one virtual object model from the original model file based on the object size and the physical material parameter, and arrange all the generated virtual object models based on the object position to complete a simulated object environment corresponding to the predefined drawing information (i.e., construct a 3D simulated object environment from a 2D virtual object environment).

If the model generation module 1213 does not search the corresponding model name and original model file in the database module 1211, it can scan and simulate a 3D form based on multiple 2D image layers in the predefined drawing information, and archive the 3D form in the database module 1211 based on the object name for use as a new original model file.

The model generation module 1213 scans multiple 2D image layers and can further analyze the object curve of the predefined object in the predefined drawing information to simulate the 3D form by using the object curve parameters.

The model generation module 1213 can further change the virtual object model according to a physical property parameter, so that the virtual object model has corresponding physical properties. The physical property parameters include:
(1) Mechanical Properties: These properties describe how an object behaves and responds when subjected to forces. They include the following categories:
   (a) Hardness: The ability of an object to resist deformation, scratching or wear. For example, diamonds are extremely hard.
   (b) Elasticity: The ability of an object to regain its original shape after being subjected to force, such as the elasticity of rubber.
   (c) Plasticity: The ability of an object to permanently deform after being subjected to force, such as the plastic deformation of metal during the forging process.
   (d) Toughness: The ability of an object to absorb energy without breaking, such as the toughness of steel.
   (e) Strength: The ability of an object to resist breakage or deformation, including tensile strength, compressive strength, etc.
(2) Thermal Properties: They are properties related to the interaction of an object with thermal energy, including the following categories:
   (a) Thermal Conductivity: The ability of an object to conduct thermal energy. For example, metals usually have higher thermal conductivity.
   (b) Specific Heat Capacity: The ability of an object to absorb or release thermal energy and cause temperature change.
   (c) Thermal Expansion: The property of an object to change size as its temperature changes.
   (d) Melting Point and Boiling Point: The temperature at which a substance changes from solid to liquid or from liquid to gas.
(3) Electrical Properties: These properties describe how an object responds to electric current and electric fields. They include the following categories:
   (a) Electrical Conductivity: The ability of an object to conduct electric current. For example, copper has extremely high electrical conductivity.
   (b) Electrical Resistivity: The ability of an object to resist the flow of electric current.
   (c) Dielectric Constant: The ability of an object to store electrical energy in an electric field.
   (d) Electromagnetic Properties: The response of an object to magnetic field and electric field, such as the magnetism of iron.
(4) Magnetic Properties: These properties describe how an object responds to magnetic fields. They include the following categories:
   (a) Magnetic Permeability: An indicator of the ability of an object to conduct magnetism.
   (b) Magnetic Susceptibility: The degree to which an object becomes magnetized when exposed to an external magnetic field.
   (c) Remanence: The magnetism retained by an object after the external magnetic field is removed.
   (d) Coercivity: The strength of the reverse magnetic field required to eliminate the remanence of an object.
(5) Density: The mass of an object per unit volume.
(6) Specific Gravity: The ratio of the density of an object to the density of water.
(7) Transparency: The degree to which an object allows light to pass through it.
(8) Viscosity: The resistance of a fluid to flow within an object.

The model generation module 1213 can further change the virtual object model according to an object motion attribute parameter, so that the virtual object model has a corresponding motion behavior. The object motion attribute parameters include:
(1) Position: The position is the specific location of an object in space, usually expressed as coordinate values in a coordinate system. It is used to determine the specific location of an object at a certain moment and is the basic parameter for describing motion.
(2) Displacement: Displacement is the linear distance and direction of an object from its initial position to its final position, and it is a vector quantity. It is used to describe the total change in the motion of an object without concern for the length of the path during the motion.
(3) Distance: Distance is the total distance traveled by an object in motion and is a scalar quantity. It is used to measure the total distance actually traveled by an object in motion. Unlike displacement, the distance does not take direction into account.
(4) Velocity: Velocity is the speed and direction of an object in motion and is a vector quantity. It is used to describe the instantaneous state of an object in motion, including its direction and speed.
(5) Acceleration: Acceleration is the speed and direction of change of the velocity of an object and is a vector quantity. It is used to describe the rate of change of an object in motion state, such as an increase or decrease of velocity, or change of direction.
(6) Time: Time is the duration of events that occur during the motion of an object. It is used to calculate parameters such as velocity, acceleration, displacement, etc. and is the basic quantity for analyzing the motion process.
(7) Force: Force is the reason that causes the change of the motion state of an object and is a vector quantity. It is used to describe the push or pull acting on an object, to determine the object's acceleration and direction of motion.
(8) Momentum: Momentum is the measure of the amount of motion of an object and is a vector quantity. It is used to describe the inertia of the motion of an object. Momentum conservation is an important principle for analyzing collisions and interactions.
(9) Energy: Energy is the ability required for an object to move or change its state, mainly including kinetic energy and potential energy. It is used to describe the ability of an object in a motion state. Energy conversion and conservation are fundamental concepts in the analysis of motion and system behavior.
(10) Work: Work is the conversion of energy done by a force to move an object a certain distance in the direction of the force and is a scalar quantity. It is used to describe the ability of a force to do work on an object and is closely related to energy conversion.
(11) Power: Power is the work completed per unit time. It describes the speed of energy conversion and is a scalar quantity. It is used to measure the rate of energy conversion or work and often used to describe the performance of equipment such as an engine and a motor.
(12) Inertia: Inertia is the ability of an object to maintain its motion state (stationary or linear motion) and is related to the mass of the object. Inertia determines the magnitude of the acceleration of an object when subjected to a force and is the basis of Newton's laws of motion.
(13) Angular momentum: Angular momentum is a measure that describes rotational motion and is a vector quantity. It is used to describe the rotational motion state of an object. Conservation of angular momentum is an important principle for analyzing rotating systems.
(14) Moment of Inertia: Moment of inertia is a measure of an object's resistance to rotational motion, which depends on the mass distribution of the object and the position of the rotation axis. It is used to affect the angular acceleration of an object and is related to angular momentum and torque.
(15) Torque: Torque is the force that causes an object to rotate and is a vector quantity. It is used to describe the rotational force applied to an object and affects the object's angular acceleration and rotational state.

The subject application provides three embodiments. The first embodiment is to establish a digital twin of a real production line. The digital twin has the same appearance, behavior and operation logic as the production line. The KPI of the system is generated after simulation, allowing customers to evaluate the performance of the system on their own.

The implementation process of the first embodiment is as follows:
(1) The user first uploads a factory design (such as a CAD file). Afterwards, the system can automatically identify the types and sizes of various equipment, determine their locations in the factory, and convert all dimensional units into international standard units.
(2) The corresponding generative model (original model file) is obtained based on the equipment name, and a 3D model (virtual object model) of the equipment is generated with the correct specifications based on the attributes, and then it is placed at the location in the factory. It is able to query the physical properties from the database, to set physical parameters and physical material of appearance for each sub-component of the 3D model of the equipment.
(3) Afterwards, an object motion attribute parameter is imported so that the 3D model of the equipment can be simulated. The production efficiency of the production line can be recorded in the system, and the results can be output after the simulation is completed.
(4) The system will also compile the production capacity data recorded during the simulation process into an analysis report and export it as a CSV file.

Among them, for the first embodiment, a more detailed generation description will be given for generating a simulated conveyor with equivalent specifications:
(1) From the CAD file, extract the properties of the conveyor block (length, width, and location in the factory).
(2) The generative model of the conveyor is read, and the dimensional specifications is input into the model. By utilizing the pre-established 3D model of the conveyor (original model file), the deformation of the conveyor is controlled with the attributes of the input data (adjusting the size of the conveyor according to the input data).
(3) The corresponding physical properties are set according to the 3D part name of the conveyor.
   (a) Rigid body physical properties are added to specific metal structures (housing, track, main frame, axis).
   (b) Physical properties, such as friction coefficient and acceleration direction (for pushing cargo), are added to the tracked objects.
   (c) The material physical parameters of appearance for setting all objects (metal, rubber, refractive index, etc.).
(4) The interactive relationship and the controller are set up for the entire conveyor system.
   (a) A virtual distance sensor is established for the conveyor (to detect whether there is a product on the conveyor belt).
      (a1) At the beginning of the sub-conveyor on the lower level of the 3D conveyor, 180 straight lines are established within a range of 180 degrees in front of this point as scanning lines;
      (a2) At the end of the sub-conveyor on the lower level of the 3D conveyor, 180 straight lines are established within a range of 180 degrees in front of this point as scanning lines;
      (a3) At the end of the sub-conveyor on the upper level of the 3D conveyor, 180 straight lines are established within a range of 180 degrees in front of this point as scan lines.
   (b) Establish controller logic (decompose the actual mechanical operation process into system process).
      (b1) The virtual sensor at the beginning of the sub-conveyor on the lower level of the 3D conveyor uses 180 scanning lines to observe whether there is an overlap with any 3D object in the 3D space. If there is an overlap, it means that cargo have arrived at the front section of the conveyor, the acceleration physical property of the track will be adjusted to 20 cm/S to start pushing the cargo forward;
      (b2) At the end of the sub-conveyor on the lower level of the 3D conveyor, 180 scanning lines are used to observe whether there is an overlap with any 3D object in the 3D space. If there is an overlap, it means that cargo have arrived at the rear section of the conveyor, the elevator is controlled to lower the conveyor, and then raise the elevator after receiving the cargo;
      (b3) At the end of the sub-conveyor of the upper level of the 3D conveyor, 180 scan lines are used to observe whether there is overlap with any 3D object in the 3D space. The acceleration physical property of the track is adjusted to 20 cm/s to start pushing the cargo forward.

Among them, for the export system simulating the KPI in the first embodiment, during the simulation process, the station at the end of the conveyor of the upper level continuously records the number of cargos shipped from here. After the simulation, the KPI data accumulated during the simulation process is aggregated to generate reports.

The second embodiment of the subject application is to convert a PCB board into a 3D model, and the pre-process of the second embodiment includes the following:
(1) Pre-process:
   (a) First, the PCBA design document is parsed to obtain the appearance of the PCB board, each electronic component type, the configuration (footprint) of the contact solder joints, component specifications and positions, and store them in the database.
   (b) Afterwards, defective solder sample images and definitions (such as shape or position) of various electronic components of PCBA are collected, and the light sources of various AOI inspection machines are collected. Afterwards, a multimedia knowledge base of defective solder sample images and text definitions of electronic components are established in the database.
   (c) After that, various solder samples and definitions are analyzed, and the solder original model files (sample generator) of various electronic components are generated through the model generation module.
(2) After the user inputs the PCBA document, an empty board model can be simulated, and multiple 3D PCBA models can be generated through the solder original model file, and then the multiple PCBA models can be arranged on the empty board model.
(3) After that, the 3D PCBA model and the simulated AOI light source parameters are imported, and the image is rendered. Finally, the image is exported, and the component candidate frame is set to cut out the components in the image to store them as a perfect sample.

Among them, an empty board model is simulated, which is further explained as follows:
(1) Regarding the shape of the PCB board, the image layer of the board frame is extracted from the dozens of stacked layers in the BERGER file, and then the board frame line plus the board thickness information are used to generate a 3D form model of the empty board.
(2) Regarding the appearance properties of the PCB board, the image layers representing the circuit and top-level printing are extracted from the dozens of stacked layers in the BERGER file, and then the circuit and the top-level printing are converted into two pictures, which are then superimposed together for image processing to become the appearance physical parameters of the PCB board.

Among them, multiple flawless 3D PCBA models are generated, which are further explained as follows:
(1) First, the component type, size specification, and location (XY coordinates) will be read from the BOM table row by row. The BOM table can be embedded in the BERGER file or inputted additionally. The BOM table of a general PCB board may contain the following information:
   (a) Reference Designator: The unique identifier of each component on the circuit board, consistent with the circuit diagram and PCB layout. These designators correspond to the silkscreen marks on the PCB and help locate the accurate position of the components on the board.
   (b) Component Type/Category: It is used to display the category of components. Through this column, the function of the component in the circuit and its application can be quickly understood.
   (c) Part Description: It provides a detailed description of the component, including technical specifications. This information helps purchasers and engineers quickly identify characteristics of components.
   (d) Specification: It includes the electrical and physical specifications of the component, such as electrical parameters, package size, accuracy, withstand voltage and other further technical parameters.
   (e) Footprint/Package: Footprint is the package type of component, which is used to describe how the component is installed on the PCB. Footprint is closely related to the pad design on the PCB, to ensure that the components can be correctly mounted on the circuit board.
   (f) Location/Placement: The BOM table does not necessarily provide the XY coordinates of the component directly, but it will indirectly provide the location of the component through the reference designator. The component location information is sometimes included in the PCB layout diagram or provided by the placement file generated by the wiring design tool.
   (g) Manufacturer: It is the manufacturer information of the component, helps procurement personnel confirm the correct source of the component, especially when there may be slight technical differences between the components of different brands.
   (h) Manufacturer Part Number (MPN): It is a specific component model, uniquely identifies a component produced by a certain manufacturer, and is used to accurately order components and avoid purchasing errors.
   (i) Supplier Name and Supplier Part Number (SPN): If the components are purchased through a third-party supplier, this information will list the supplier name and supplier part number.
   (j) Quantity: It is used to display the quantity of each component required in the PCB design, making it easier to understand the quantity required for each component when ordering.
   (k) Notes/Comments: They may contain additional instructions or comments, such as replacement components, test components, or special installation requirements.
(2) The component type is used to read the corresponding generative model (solder original model file), and the size specification is input into the model. Further explanation is as follows:
   (a) A 3D cube is created with the input length, width, and height as a rough model of the capacitor.
   (b) The cube is divided into three sections, each representing:
      (b1) Regarding the left metal terminal of the capacitor, the length of the metal terminal is ((total length-body length)/2).
      (b2) Regarding the middle body of the capacitor, the length of the middle body of the capacitor is the body length.
      (b3) The right metal terminal of the capacitor.
   (c) The vertical corners of the metal terminals and the cube in the middle body of the capacitor are rounded to make the edges look chamfered, to achieve the purpose of being closer to the real situation.
   (d) The length, width, and height information of the footprint of component are read, and then two cubes with corresponding sizes are generated as the 3D model of the pad and placed under the metal terminals at both ends.
   (e) The space from the top of the electronic component terminal to the end of the solder pad is analyzed. For example, a “side curve” that complies with the “correct solder” from the first point to the second point is calculated, so as to generate a 3D model of the solder according to this curve. At this moment, the 3D model has the electronic components, the solder pads and tins. The first point is the top edge of the metal terminal, and the second point is the end of the pad.
   (f) Each 3D model with electronic components, solder pads and tin is placed in the corresponding position on the PCB board.

In addition to the perfect solder, the subject application can also produce various defective solder defect generators (solder original model files) through the model generation module, mainly based on MLCC, solder pads, and solder generators, to generate a 3D model that can produce a variety of solder defects. Therefore, the technology of the subject application can not only be used to generate functions that approximate real samples (such as: geometry simulation and picture structure approximation, etc.) and can also be used to produce diversified defect samples.

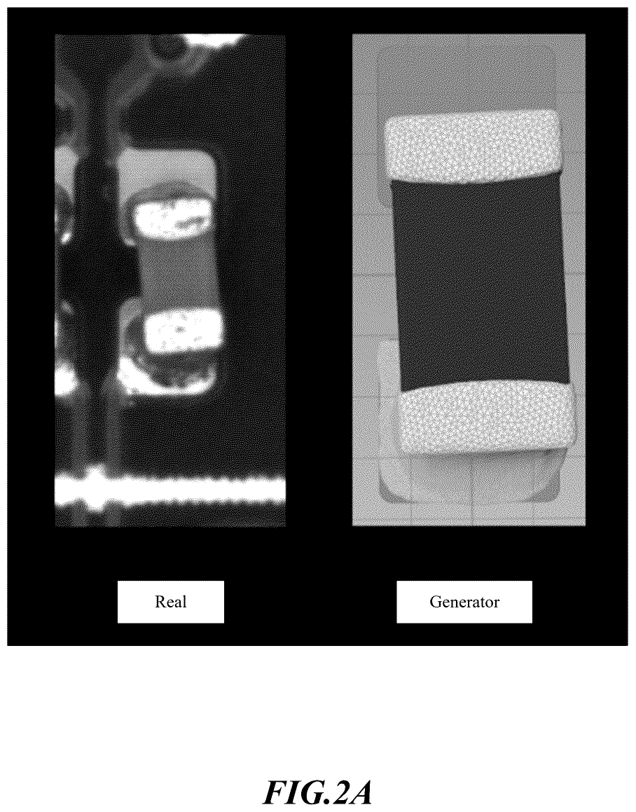

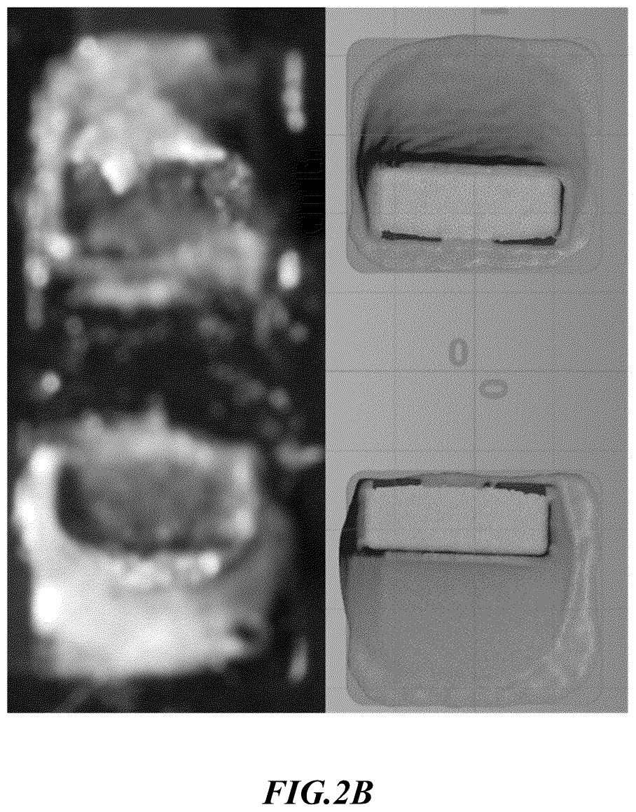

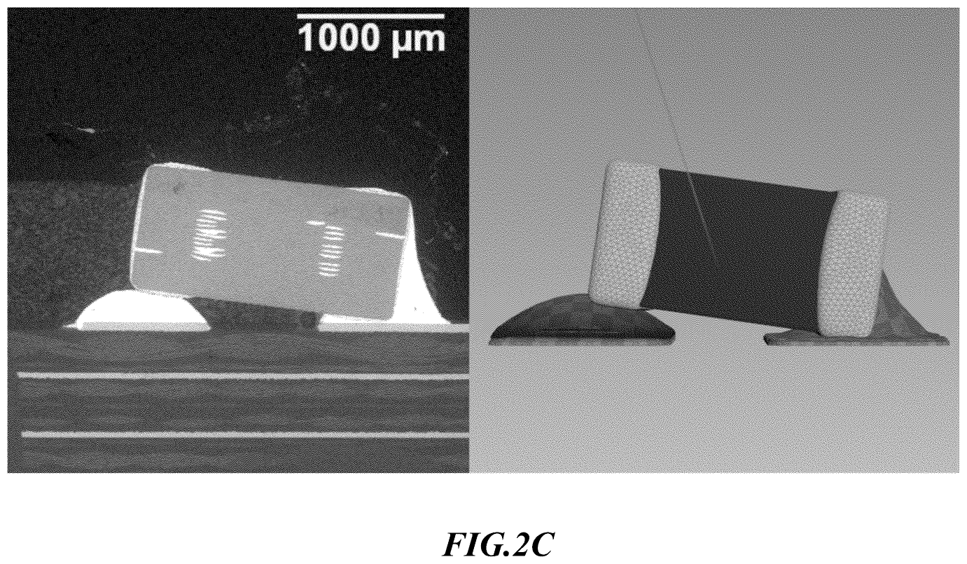

As illustrated in FIGS. 2A, 2B and 2C, they are all different embodiments of simulating 2D object information files to generate 3D models through the technology of the subject application. The left side is the real object information file, and the right side is the generated 3D model.

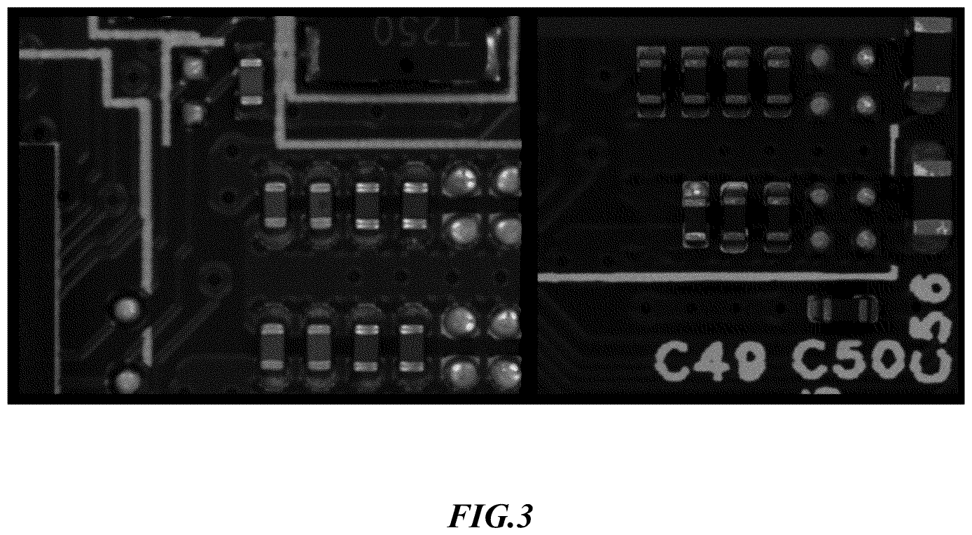

In addition, the subject application can further measure the materials of electronic components and produce physically accurate 3D materials according to different materials, close to the surface color, refraction, and roughness properties of the real sample. The following is an example of AOI machine light source simulation:
(1) The actual light source inside the AOI machine is photographed by a panoramic camera and recorded in EXR format.
(2) The HDR light source of AOI is imported into a computing platform or computing software (such as Omniverse). Specific software (such as NVIDIA's ray tracing) is used as a simulator, to generate the synthetic data of the PCBA 3D model under EXR light source and save it as a picture.
(3) The solder joints of electronic components are the main analysis object to check the difference in visual performance between synthetic data and real samples in reflecting the ambient light.
(4) The color and position of the EXR light source are edited, and repeated testing is performed until the synthetic data and the real sample have the same visual performance in reflecting the ambient light.
(5) Finally, by importing the 3D model and light source EXR generated by this technology into specific software (such as NVIDIA Omniverse) for light simulation, a final image close to the real sample can be obtained.
(6) As shown in FIG. 3, the left side is a photo taken under a real AOI, and the right side is a simulated photo generated using the technology of the subject application.

Regarding the third embodiment of the subject application, the third embodiment is a building automatic generator based on a parametric model. The purpose is to automatically generate corresponding 3D building models by parsing 2D CAD files in association with procedural modeling technology. In the generated 3D model, all single objects are accompanied by their parameter information, such as the length, width, height and position of the column, to facilitate subsequent design adjustments or structural analysis. Users only need to provide a folder containing CAD drawings. The system can read and automatically generate a parametric 3D model that complies with building regulations.

The third embodiment of automatic building generation logic includes the following:
(1) Input CAD floor plan and section drawings of each floor.
   (a) The input drawing files can support common drawing logic based on polygons (Polyline), multi-lines (Mline) and blocks (Block), for example:
      (a1) Wall: Multiple lines indicate thickness and contour.
      (a2) Floor: Polygon indicates contour.
      (a3) Doors, windows and columns: Blocks indicate location, size and type.
   (b) The input drawing files can further contain dynamic block attributes. In addition to the function of accelerating drawing, the dynamic blocks can also carry more attributes, including model, size, etc., which are suitable for more complex objects.
(2) The subject application can automatically classify and extract data such as floors, walls, columns, doors, windows, tables, etc. in CAD image layers, and convert them into structured dictionaries.
(3) Creating a generative model is explained as follows:
   (a) Digital asset generation logic: It uses the structured dictionary extracted by the automatic image reading mentioned above for corresponding to the parameters of the generative model to generate objects. For example:
      (a1) Floor generation: each floor structure is generated according to floor outline and height parameters.
      (a2) Wall generation: a wall model is generated that complies with the specifications based on multiple wall lines.
      (a3) Door and window generation: Embedded door and window models are generated based on the door and window block attributes.
      (a4) Generation of structural beams, columns, shear walls, etc.: Structural models are generated based on location and detailed drawing tables (including model number, cross-sectional dimensions, etc.).
   (b) An algorithm is used that complies with building structural regulation and verification, the algorithm of the generative model in the subject application will ensure that the generated objects comply with building structural regulations. The priority of objects exists in building structures. For example: columns and shear walls cannot be truncated, beams can be truncated by columns and shear walls, floors and walls can be truncated by all of the above objects.

The subject application can further achieve the goal of one-click model generation, which can be illustrated by the third embodiment as follows:
(1) The technologies of the subject application can be connected through a computing platform (such as Omniverse) to generate an application program;
(2) Afterwards, by inputting a folder containing CAD drawings, the internal architectural drawings, soft furnishing drawings, structural drawings, cross-section drawings and other drawings are read, and the automatic drawing reading system extracts the parameters inside;
(3) Finally, based on the structured dictionary generated from the parsed parameters, the application program corresponds to the generative model and outputs it in OpenUSD format with object parameters for subsequent design adjustments and applications (such as calculating quantities, etc.).

The third embodiment of the subject application has the following characteristics, which are explained as follows:
(1) Efficient automation: It supports the rapid processing and model generation of large-scale multi-story building data.
(2) Flexible data analysis: It enables CAD to be drawn according to the drawing logic commonly used by architects, and the drawings can be directly output without the need for additional drawing or learning. The model with parameters can be automatically generated.
(3) Parameterization and visualization: Each generated 3D model object comes with parameters, such as the length, width and height of a column, the thickness and height of a wall, to support programmatic adjustment and visualization.

The third embodiment mentioned above provides a building automatic generation system based on parametric modeling technology, which can convert 2D CAD data into a 3D model having complete parameters. The system supports flexible adjustment and parameter visualization, saves the time of architects in modifying 2D drawings and 3D models back and forth, improves design efficiency significantly and ensuring building specifications, and provides innovative solutions for architectural design and engineering analysis.

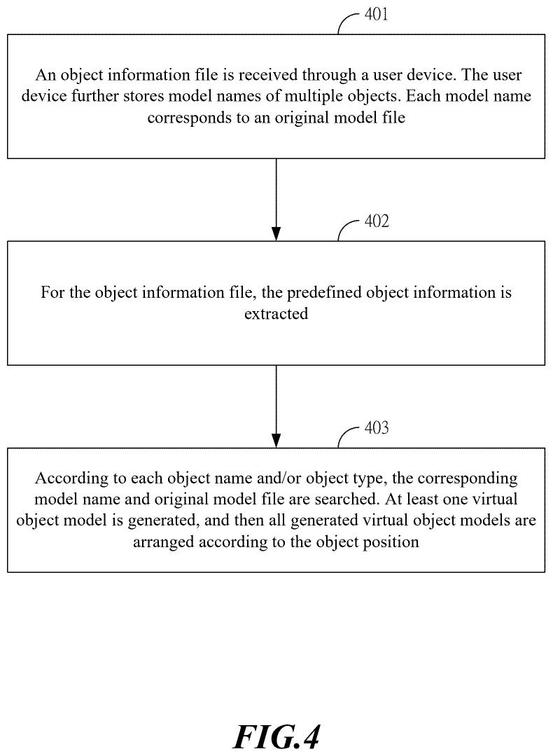

The 3D model generation method of the subject application is illustrated in FIG. 4, and the method includes:
(1) An object information file is received through a user device. The object information file has a predefined drawing information and predefined object information, the predefined drawing information has at least one predefined object, and the user device further stores model names of multiple objects. Each model name corresponds to an original model file, and the original model file has at least one physical material parameter 401;
(2) For the object information file, the predefined object information is extracted. The predefined object information at least includes an object name, an object type, an object position and an object size 402;
(3) According to each object name and/or object type, the corresponding model name and original model file are searched. The original model file is used to generate at least one virtual object model according to the object size and the physical material parameters. Afterwards, all generated virtual object models are arranged according to the object position, to complete a simulated object environment that corresponds to the predefined drawing information 403.

Compared with other conventional technologies, the 3D model generation system and its method provided by the present invention provide the following advantages:
(1) The subject application allows users to input object information files and multiple parameters to generate 3D models automatically, to effectively achieve the purpose of converting 2D object information files into 3D models.
(2) By utilizing the technology of the subject application, this type of defective sample simulation can be generated, which has proven to be of great help to AI training. 100% of the data is recognized as real and effectively improves the defect detection rate of AI.

Although the present disclosure has been disclosed in the form of embodiments, they are not intended to limit the present disclosure. Anyone with ordinary knowledge in the relevant technical field and understanding of the foregoing technical features and embodiments of the present invention may make slight changes and modifications without departing from the spirit and scope of the present disclosure. Therefore, the scope of protection of the present invention shall be subject to the scope of the claims attached to the specification herein.

What is claimed is:

1. A 3D model generation system, comprising:
a user device, comprising a model generation application program unit, wherein the model generation application program unit comprises:
a database module, used to store model names of multiple objects, wherein each of the model names corresponds to an original model file, and the original model file has at least one physical material parameter;
an identification module, connected to the database module to receive an object information file, wherein the object information file comprises a predefined drawing information and a predefined object information, the predefined object information can be included or not included in the predefined drawing information, the predefined drawing information comprises at least one predefined object, the identification module can extract the predefined object information. and the predefined object information comprises at least an object name, an object type, an object position and an object size; and
a model generation module, connected to the database module and the identification module to search the corresponding model name and the original model file in the database module based on each object name or/and the object type, and generate at least one virtual object model from the original model file based on the object size and the physical material parameter, and arrange all the generated virtual object models based on the object position to complete a simulated object environment corresponding to the predefined drawing information.

2. The 3D model generation system according to claim 1, wherein if the model generation module fails to search the corresponding model name and the original model file in the database module, the model generation module can scan multiple 2D image layers in the predefined drawing information to simulate a 3D form, and the 3D form is archived in the database module according to the object name to be used as a new original model file.

3. The 3D model generation system according to claim 2, wherein the model generation module scans multiple 2D image layers and is further capable of analyzing an object curve of the predefined object in the object information file to simulate the 3D form for the object curve parameter.

4. The 3D model generation system according to claim 1, wherein the physical material parameter comprises one or at least one parameter of a color parameter, a texture parameter, a reflectivity parameter, a specular highlight parameter, a roughness parameter, a metallic property parameter, a transparency parameter, an opacity parameter, an emissive property parameter, a normal map parameter, a bump map parameter, an ambient occlusion parameter, a glossiness parameter, a subsurface scatterings parameter, and an anisotropy parameter.

5. The 3D model generation system according to claim 1, wherein the model generation module is further capable of changing the virtual object model according to a physical property parameter so that the virtual object model has corresponding physical properties.

6. The 3D model generation system according to claim 5, wherein the physical property parameter comprises one or at least one parameter of a mechanical property-related parameter, a thermal property-related parameter, an electrical property-related parameter, a density parameter, a specific gravity parameter, and a viscosity parameter.

7. The 3D model generation system according to claim 1, wherein the model generation module is further capable of changing the virtual object model according to an object motion attribute parameter so that the virtual object model has corresponding motion behavior.

8. The 3D model generation system according to claim 7, wherein the object motion attribute parameter comprises one or at least one parameter of a displacement parameter, a moving distance parameter, a speed parameter, an acceleration parameter, a duration parameter, a push or pull parameter, an object motion parameter, a momentum parameter, a kinetic energy parameter, a potential energy parameter, a power parameter, an angular momentum parameter, a moment inertia parameter, and a torque parameter.

9. A 3D model generation method, comprising:
receiving an object information file through an user device, wherein the object information file has a predefined drawing information and a predefined object information, the object information file has a predefined drawing information and a predefined object information, the predefined object information can be included or not included in the predefined drawing information, the predefined drawing information has at least one predefined object, the user device further stores model names of multiple objects, wherein each of the model names corresponds to an original model file, and the original model file comprises at least one physical material parameter;
for the object information file, extracting the predefined object information, wherein the predefined object information comprises at least an object name, an object type, an object position, and an object size; and
searching the corresponding model name and the original model file based on each object name or/and the object type, generating at least one virtual object model from the original model file based on the object size and the physical material parameter, and arranging all the generated virtual object models based on the object position to complete a simulated object environment corresponding to the predefined drawing information.
